(19) United States
(12) Patent Application Publication
(10) Pub. No.: US 2003/0167320 A1
(43) Pub. Date: Sep. 4, 2003

(54) Registration service for registering plug-in applications with a management console

(75) Inventor: Andres M. Perez, Waltham, MA (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 10/085,258

(22) Filed: Feb. 26, 2002

(51) Int. Cl. G06F 15/173; G06F 9/00; G06F 9/46

(52) U.S. Cl. 709/223; 709/328

(57) ABSTRACT

A registration service enables one or more plug-in applications to register with a web-based application. The web-based application may be, for example, a management console for managing items in a distributed environment. The registration service enables plug-in applications to register dynamically or statically. Dynamic registration enables the web-based console to continue executing while registration is performed. In contrast, static registration occurs during initialization of the web-based console. Each plug-in application provides a registration descriptor containing information regarding the plug-in application. The registration descriptor is processed by the registration service to facilitate registration of the plug-in application.

This application is related to co-pending application, entitled “Scripting Service for Translating Browser Requests into Command Line Interface (CLI) Commands,” application No. ______ (Attorney Docket No. SMQ-084), and co-pending application entitled, “Command Line Interface (CLI) Session Tool,” application No. ______ (Attorney Docket No. SMQ-085), which were filed on even date herewith, assigned to a common assignee with the present application and explicitly incorporated by reference herein.

### TECHNICAL FIELD

The present invention relates generally to computer systems and more particularly to a registration service for registering plug-in applications with a management console.

### BACKGROUND

A “web-based” application is one that is accessed by way of a web browser over a network, such as the Internet, an intranet, an extranet or another variety of network. A typical web-based application is self-contained in that all of the functionality of the application is contained within the code or objects that constitute the application. As a consequence, conventional web-based applications are not readily extensible without directly modifying the code in the application. Each web-based application is responsible for providing its own core services, including user interface elements and navigation devices for the application.

One example of a conventional web-based application is a management application that enables a user to manage same type of resource. A management application may, for instance, manage objects that are visible within a file system. Another example of a management application is a program that manages server and storage components in a networked environment. Each management application has its own user interface, which may differ from other management applications.

### SUMMARY

Embodiments of the present invention provide a mechanism for a plug-in application to register with a web-based management console to extend the functionality of the management console. The registration is easily performed and does not require modification of the code in the management console. A plug-in application registers with a management console by providing a registration descriptor in a specified location that is locally accessible by the registration service, such as a subdirectory in a directory structure. A registration service processes the registration descriptor to register the plug-in application. Once the plug-in application is registered, the plug-in application may be executed in conjunction with the core management console components. The registration may occur statically during initialization of the management console or dynamically while the management console is running without interrupting the execution of the management console.

In accordance with a first aspect of the present invention, a method is practiced in an electronic device that interfaces with the network. In accordance with this method, a program is executed on the electronic device. A plug-in application is dynamically registered with the program without ceasing execution of the program. The plug-in application operates in conjunction with the program to provide enhanced functionality for the program. The step of dynamically registering may include the steps providing a registration descriptor that holds information regarding the plug-in application and processing the registration descriptor to complete the registering of the plug-in application. The registration descriptor may be, for example, an extensible mark-up language (XML) file.

In accordance with another aspect of the present invention, a method is performed on a server where information regarding an application is provided at a specified storage location. In response to the information being at the specified storage location, the application is registered for use in conjunction with a program on the server to provide additional functionality for the program.

In accordance with an additional aspect of the present invention, a management software package is provided on a server for managing items in a distributed environment. A location is provided where add-on programs may deposit information regarding the add-on programs to register with the management software package. The add-on programs enhance functionality of the management software package. Information at the location is processed so that the add-on programs registered and executed in conjunction with the management software package.

### BRIEF DESCRIPTION OF THE DRAWINGS

FIG. 1A depicts an environment that is suitable for practicing an illustrative embodiment of the present invention.

FIG. 1B illustrates a management application container in more detail.

FIG. 2 is a flow chart illustrating the steps that are performed to register a plug-in application.

FIG. 3 is a flow chart illustrating the steps that are performed for dynamic registration.

FIG. 4 is a flow chart illustrating the steps that are performed for static registration.

FIG. 5 depicts the high level components found in a registration descriptor.

FIG. 6A depicts the components that may form a browser element in the registration descriptor.

FIG. 6B depicts components that may constitute a CLI element in the registration descriptor.

FIG. 7 illustrates an example of a user interface for a management application, wherein a plug-in application has been used to extend the functionality of the management application.

### DETAILED DESCRIPTION

An illustrative embodiment of the present invention provides a registration mechanism for plug-in applications to register with a management console (i.e., a management application that provides a common set of core services, including user interface services) or management software package. The plug-in applications are application programs that extend or enhance the functionality of the management console. The plug-in applications may also be designated as “add-on” applications in the discussion below. The registration mechanism allows the functionality of the management console to be readily extended. Plug-in applications may register either statically or dynamically. With static registration, plug-in applications are registered during initialization of the management console prior to normal execution of the management application. In contrast, with dynamic registration, plug-in applications are registered after initialization during execution of the management application.

The registration service enables a common management console to be employed with multiple plug-in web-based applications. As a result, a single management console may provide core services to multiple plug-in applications. The registration service act as a mechanism for the management console to advertise its core services to plug-in applications.

As will be described in more detail below, the registration mechanism relies upon registration descriptors that provide information regarding plug-in applications, so that the plug-in applications may register with a management console. In the illustrative embodiment, the registration descriptors are realized as XML files that contain structured information regarding the plug-in applications. The registration service parses the XML files to extract the information that is needed to complete registration of the plug-in application.

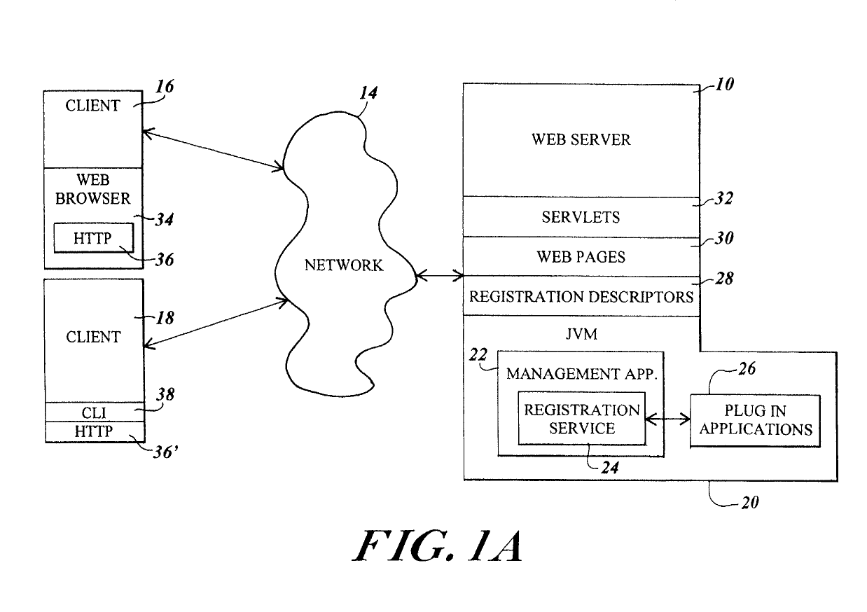

FIG. 1 shows an example of an environment that is suitable for practicing the illustrative embodiment to the present invention. The environment includes a web server 10 that is interfaced with a network 14. Clients 16 and 18 may access services provided by the web server 10 over the network 14. The clients 16 and 18 may be any of a number of different types of electronic devices, including but not limited to personal computers, workstations, Internet appliances, personal digital assistants (PDAs), intelligent pagers, set-top boxes and cellular phones. The network 14 may be any of a number of different types of computer or communications networks, including a packet switched network or a connection oriented network.

The web server 10 includes a Java Virtual Machine (JVM) 20 on which a management console 22 runs. Those skilled in the art will appreciate that the web server 10 may run multiple JVMs in some embodiments. In addition, the present invention is not limited to instances in which the management console 22 is encoded in the Java programming language. (Java is a trademark of Sun Microsystems of Palo Alto, Calif.) The choice of the management console being written in Java is purely for illustrative purposes and is not intended to limit the scope of the present invention. The management application may be written in other high level programming languages, scripting languages, and the like. Still further, the server 10 need not be a web server but can be another variety of server or host.

The management console 22 is responsible for managing items within the distributed environment shown in FIG. 1. The items may be, but are not limited to, things such as computing resources, storage facilities, switching facilities, objects, servers, processes, and users. The management console 22 provides a set of core services that may be accessed by plug-in applications 26. The core services include, but are not limited to, user interface services and navigation services. The registration service 24 is responsible for registering plug-in applications 26 with the management console 22. The registration service 24 is also responsible for creating in-memory representations of registered applications from the registration descriptors. As was mentioned above, the plug-in applications provide additional functionality to the management console or embellish the functionality that is provided by the management console. One or more plug-in applications 26 may be registered with the management console via the registration service 24. Each plug-in application has an associated registration descriptor 28, which will be described in more detail below. Web pages 30 for the management console 22 and the plug-in applications may be stored for access by the web server. The web pages may include JavaServer pages (JSPs) which encapsulate scriptlets written in the Java programming language and more traditional web page content. The logic that generates content for the page may be encapsulated within the scriptlets or within separate JavaBeans (as will be described in more detail below). Servlets 32 may also be present on the web server 10. These servlets may be part of the management console 22 or part of the plug-in applications 26.

The clients 16 and 18 may be of two varieties. In the first variety, the client 16 accesses the management console 22 via a web browser 34 over the network 14. The web browser 34 includes support for the hypertext transfer protocol (HTTP) 36. Hence, HTTP requests may be sent by the browser 34 over the network 14 to the web server 10. The HTTP request is passed onto the management console 22 that either alone or in cooperation with the plug-in applications 26 generates a response that is returned over the network 14 to the client 16. The second variety of client 18 has a command line interface (CLI) 38 where the user interacts with the management console 22 by entering commands on a command line. This client 18 also includes support for HTTP 36′.

Those skilled in the art will appreciate that the configuration shown in FIG. 1A is intended to be merely illustrative and not limiting of the present invention. The present invention may also be practiced in environments having more than two clients. Those skilled in the art will also appreciate that different components than those shown in FIG. 1A may be present on the server 10 on which the management application is running.

In the illustrative embodiment, the management console 22 is implemented as an object. This object is a container that includes other additional objects as shown in FIG. 1B. The management console container 22 encapsulates the registration service 24. As was mentioned above, the registration service 24 is responsible for registering the plug-in applications 26 with the management application 22. The management console container 22 may also include a number of JSPs 20 and a controller servlet 25. The controller servlet 25 is responsible for interacting with clients and overseeing operations performed by the management console 22. The controller servlet 25 may forward request to the JSPs 30 for further processing. The management console container 22 also may include a number of JavaBeans 27. JavaBeans are reusable programming components that provide modules of functionality. A number of action classes 31 may also be provided to perform actions in response to client activity or other events.

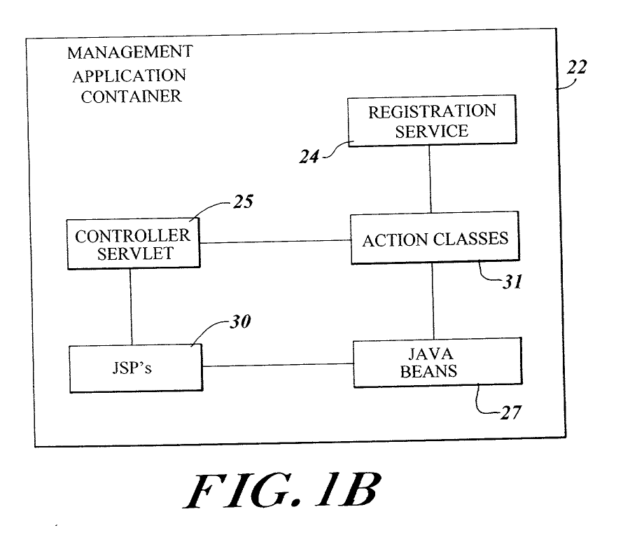

FIG. 2 is a flow chart that provides an overview of the steps that are performed for a plug-in application to register with the management console. Initially, a plug-in application 26 has a registration descriptor 28 that is created and stored at a designated location (step 50 in FIG. 2). The designated location may be a particular subdirectory or other specified location that is accessible by the management console 22. In response to the registration descriptor 28 being stored in the designated location, registration is performed by the registration service 24 (step 52 in FIG. 2). The details of the registration will be described below. Once registration is complete, the user or other client may begin interacting with the management console 22 (step 54 in FIG. 2). The functionality of the plug-in application may then be called upon and accessed as needed (step 56 in FIG. 2).

As was mentioned above, a single plug-in application 26 may be registered with the management console 22 or multiple plug in applications may be registered with the management console 22. Each plug-in application 26 must have an associated registration descriptor.

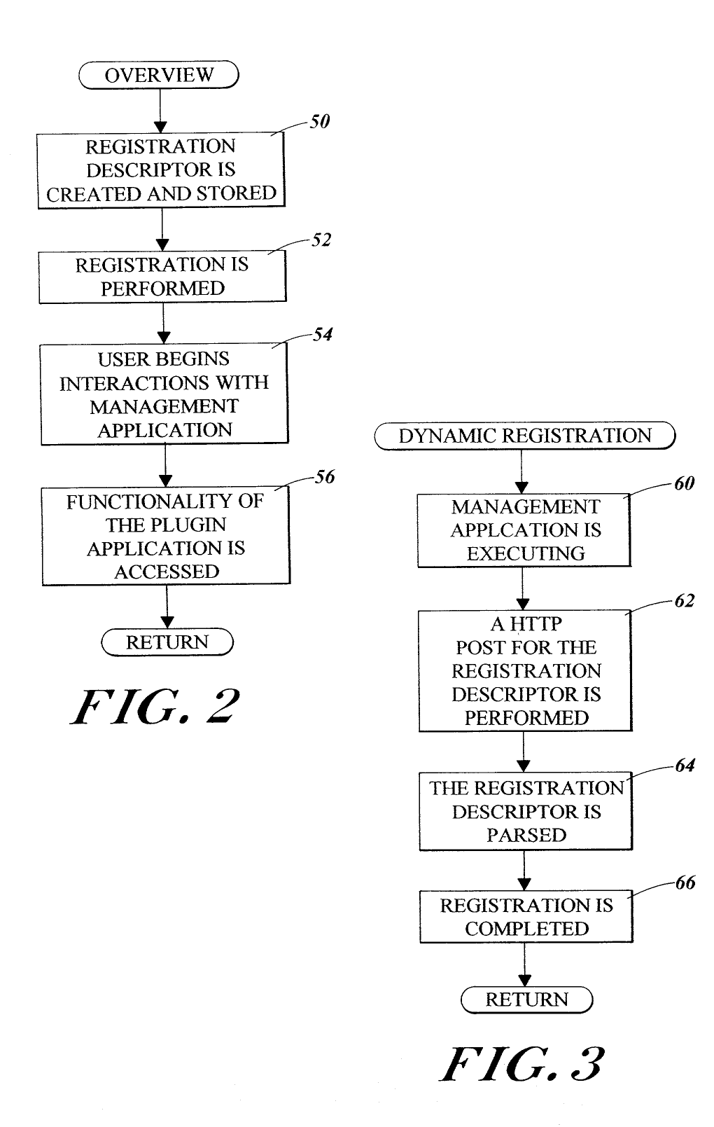

The registration of a plug-in application 26 may be either dynamic or static. FIG. 3 is a flow chart that illustrates the steps that are performed during dynamic registration. Initially, the management console 22 is executing (step 60 in FIG. 3). The plug-in application 26 issues a HTTP “post” command for the registration descriptor 28 to post the registration descriptor at the specified location (e.g., subdirectory) where registration descriptors are to be placed to effect registration (step 62 in FIG. 3). The registration descriptor 28 is then parsed by the registration service 24 (step 64 in FIG. 3). The registration of the plug-in application 26 is completed by building a Java representation of the capabilities of the plug-in application and by building the required Java objects for the plug-in application (step 66 in FIG. 3).

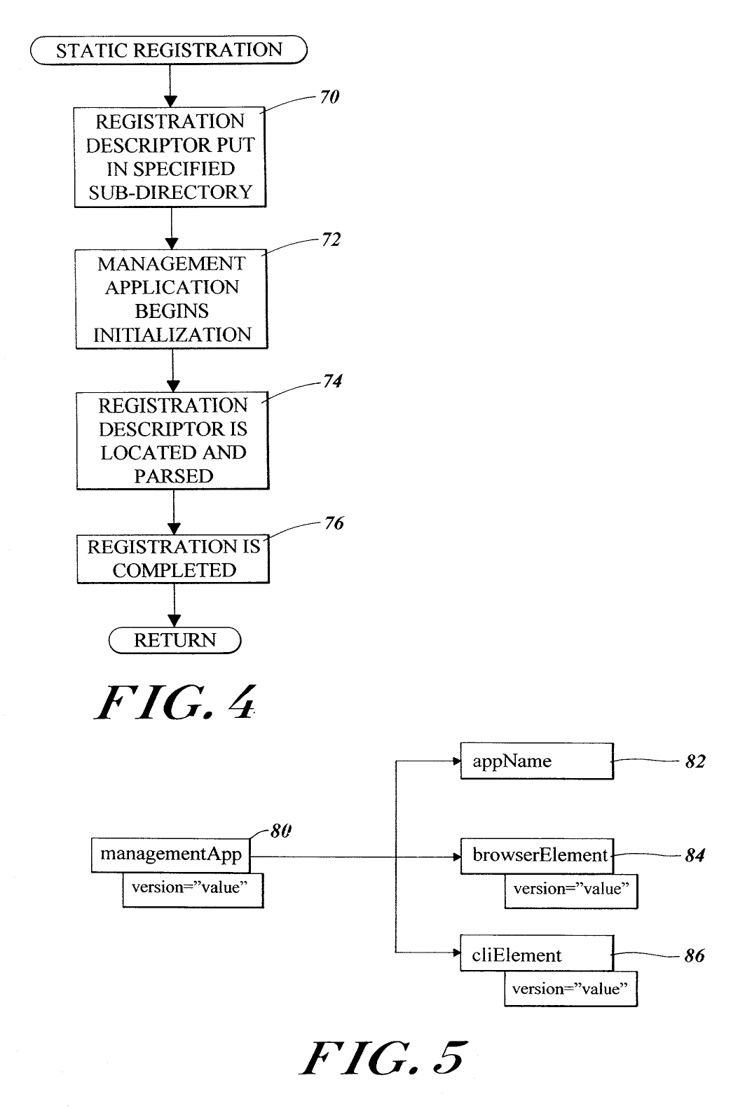

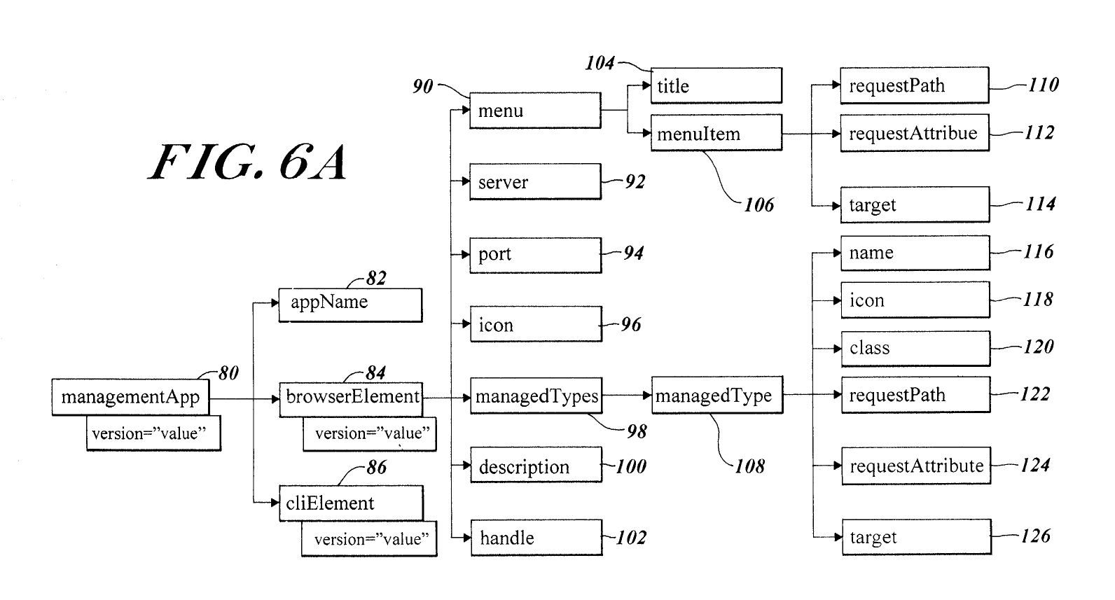

FIG. 4 is a flow chart that illustrates the steps that are performed for static registration. With static registration, the registration descriptor 28 is put in a specified subdirectory in a specified location (step 70 in FIG. 4). As the management console 22 begins initialization (step 72 in FIG. 5), the registration service 24 notes that the registration descriptor 28 is located in the specified location. The registration descriptor 28 is accessed and parsed (step 74 in FIG. 4). The other requisite steps for completing the registration are the n performed (step 76 in FIG. 4).

In order to better appreciate how the registration descriptor 28 is formed and processed, it is helpful to look at the format of the registration descriptor in the illustrative embodiment. FIG. 5 depicts the high level organization of a registration descriptor 28 in the illustrative embodiment. As was mentioned above, in the illustrative embodiment, the registration descriptor 28 is an XML file. Nevertheless, those skilled in the art will appreciate that the registration descriptor 28 may be in other formats, including but not limited to a text file, an HTML file, or other variety of data structure.

As an XML file, the registration descriptor 28 includes tags and data fields. The root element in the registration descriptor structure is a tag of type managementApp 80. This tag 80 has only a version attribute that specifies the particular version number of the plug-in application. The next level of the hierarchy contains three tags, an appName tag 82, browserElement tag 84 and cliElement tag 86. The appName tag 82 contains the name under which this plug-in application is known to the web server 10. The browserElement tag 84 contains information needed to run the application as a plug-in. The cliElement tag 86 holds any additional information needed by the CLI client infrastructure of the management console.

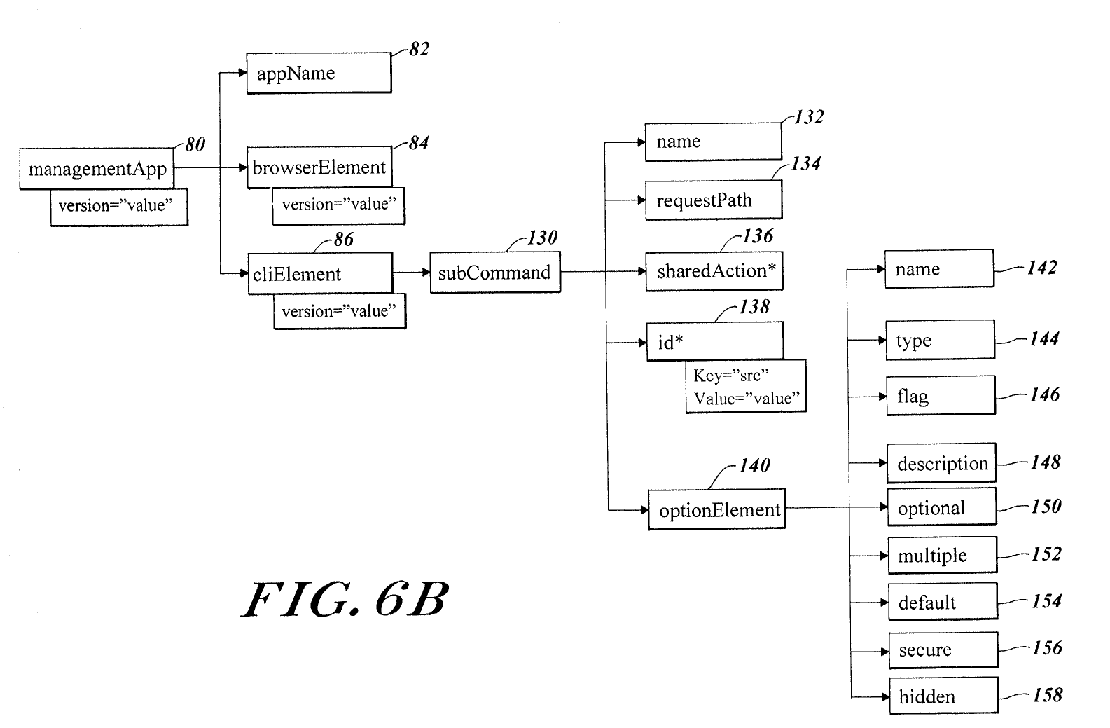

As shown in FIG. 6A, the browserElement tag 84 contains a number of other tags that define attributes that are of interest to the management console 22. The menu tag 90 contains a description of any menus which the plug-in application wishes to make available to the user. For each menu, there is a title tag 104 that specifies the title of the menu and a menu item tag 106 for each menu item in the menu. The menu item tag 106 may, in turn, contain additional tags. The request path tag 110 specifies where the request from the client is to be sent to the plug-in application when the menu item is selected. The request attribute tag 112 identifies any request attributes that will be sent as part of the request, and the target attribute 114 specifies the name of a frame or application window where the plug-in application's response will be displayed.

The browserElement tag 84 may also contain an optional server tag 92 that identifies the machine that is hosting the management console 22. A port tag 94 may be provided that identifies the port number for the server that is servicing the plug-in application. An icon tag 96 contains information identifying a graphical icon that represents the plug-in application.

The managedTypes tag 98 contains information regarding items that the plug-in application is willing to manage.

The description tag 100 contains a text description of the plug-in application. The handle tag 102 contains a human readable name for the plug-in application.

For each management type specified in the managedTypes tag 98 there is a manageType tag 108. In addition, for each managed type, there is name tag 116 that specifies the human readable name of the item that is to managed, and as an icon tag 118 for an icon to associate with an instance of the item. A class tag 120 specifies the implementation class or interface which objects of the specified type implement. A requestPath tag 122 specifies a path to a servlet, JSP or other executable that will return a response to a client request. A requestAttribute tag 124 holds any attributes that are forwarded with the requests, and the target tag 126 holds information regarding the name of the frame or application window where the response will be displayed.

There is a document type descriptor (DTD) for the browserElement tag portion of the registration descriptor. An example of such a DTD is as follows:

<?xml version=“1.0” encoding=“UTF-8”?>
<!ELEMENT class (#PCDATA)>
<!ELEMENT description (#PCDATA)>
<!ELEMENT handle (#PCDATA)>
<!ELEMENT icon (#PCDATA)>
<!ELEMENT managedType (name, icon, class, request, requestAttribute+,
target)>
<!ELEMENT managedTypes (managedType+)>
<!ELEMENT managementApp (server, port, name, icon, description,
handle, managedTypes, menu+)>
<!ELEMENT menu (menuItem | menu)+>
<!ATTLIST menu

title CDATA #REQUIRED

>
<!ELEMENT menuItem (requestPath, requestAttribute+, target?)>
<!ATTLIST menuItem

label CDATA #REQUIRED

>
<!ELEMENT name (#PCDATA)>
<!ELEMENT port (#PCDATA)>
<!ELEMENT requestPath (#PCDATA)>
<!ELEMENT requestAttribute EMPTY>
<!ATTLIST requestAttribute

name CDATA #REQUIRED
value CDATA #REQUIRED

>
<!ELEMENT server (#PCDATA)>
<!ELEMENT target EMPTY>
<!ATTLIST target

value CDATA #REQUIRED

>
<!ATTLIST managementApp

version CDATA #REQUIRED

>
<!ATTLIST browserElement

version CDATA #REQUIRED

>
<!ATTLIST cliElement

version CDATA #REQUIRED

An example of an XML file registration descriptor that conforms with the DTD set forth above is as follows:

<?xml version=“1.0” encoding=“UTF-8”?>
<?xml-stylesheet type=“text/xsl” href=“C:\WINNT\Profiles\
Administrator\Desktop\app.xsl”?>
<!DOCTYPE managementApp SYSTEM “C:\WINNT\Profiles\
Administrator\Desktop\app.dtd”>
<managementApp>

<!--element describing host running application-->
<server>axis</server>
<!--the port number for web server servicing this application-->
<!--port>8080</port>
<application name as pertains to construction of request URLs-->
<name>nsm_proto</name>
<!--Icon to be used for this application-->
<icon>images/applcon.gif</icon>
<!--Arbitrary length description of this management application-->
<description>
This application manages A5K and T300 devices. It is implemented
as a Servlet/JSP compliant web application. It defines one top-level
menu to be added to the containing application's menu structure.
</description>
<!--Human-readable name for the application-->
<handle>Element Manager</handle>
<!--This element lists the SAN entities that this application knows

how to manage-->

<managedTypes>

<!--The individual device types managed by this application-->
<managedType>

<!--The human-readable name for this device type-->
<name>T3 Device</name>
<!--An application-defined icon for this device type. The

URL specified can be relative or absolute-->

<icon>images/T3.gif</icon>
<!--The implementation class or interface which objects of

this type implement-->

<class>com.sun.metro.device.T3Device</class>
<!--The request to be sent to server hosting this app. Could

be a servlet or a request, which maps to a servlet-->

<request>ProcessDeviceSelection.do</request>
<!--An arbitrary number of request attributes-->
<requestAttribute name=“type” value=“T3”/>
<!--This element specifies where in the overall UI the

response to this request should go-->

<target value=“detailsFrame”/>

</managedType>
<managedType>

<name>A5K Device</name>
<icon>images/A5k.gif</icon>
<class>com.sun.metro.device.A5kDevice</class>
<request>ProcessDeviceSelection.do</request>
<requestAttribute name=“type” value=“A5k”/>
<requestAttribute name=“another” value=“anotherVal”/>
<target value=“detailsFrame”/>

</managedType>

</managedTypes>
<!--This element allows applications to define application-specific

menus which base metropolis will add to the top-level menu system.
Menus can be nested to arbitrary depth-->

<menu title=“Menu1”>

<!--Element describing an individual menu item and the HTTP

request associated with it-->

<menuItem label=“Item 1”>

<!--The HTTP request (servlet, JSP, ...) associated with this

menu item-->

<request>ProcessMenuItem.do</request>
<!--Arbitrary length list of attributes so send along with

the request. This is in addition to the unique ID which will identify the
current node to the application-->

<requestAttribute name=“type” value=“A5k”/>
<requestAttribute name=“another” value=“anotherVal”/>
<!--UI target where to install response from this menu

item's associated request-->

<target value=“newFrame”/>

</menuItem>
<!--This is a nested menu (pullright) containing two menu

items-->

<menu title=“Another Menu”>

<menuItem label=“Item 1”>

<request>ProcessMenuItem.do</request>
<requestAttribute name=“type” value=“A5k”/>
<requestAttribute name=“another”

value=“anotherVal”/>

<target value=“newFrame”/>

</menuItem>
<menuItem label=“Item 1”>

<request>ProcessMenuItem.do</request>
<requestAttribute name=“type” value=“A5k”/>
<requestAttribute name=“another”

value=“anotherVal”/>

<target value=“anotherFrame”/>

</menuItem>

</menu>
<!--Another menu item for this menu-->
<menuItem label=“item 2”>

<request>ProcessMenuItem.do</request>
<requestAttribute name=“type” value=“A5k”/>
<requestAttribute name=“another” value=“anotherVal”/>
<target value=“anotherFrame”/>

</menuItem>
<menuItem label=“item 3”>

<request>ProcessMenuItem.do</request>
<requestAttribute name=“type” value=“A5k”/>
<requestAttribute name=“another” value=“anotherVal”/>
<target value=“newFrame”/>

</menuItem>

</menu>
<!--Another top level menu-->
<menu title=“Menu2”>

<!--Element describing an individual menu item and the HTTP

request associated with it-->

<menuItem label=“Item 1”>

<!--The textual label for this menu item-->
<request>ProcessMenuItem.do</request>
<requestAttribute name=“type” value=“A5k”/>
<requestAttribute name=“another” value=“anotherVal”/>
<target value=“newFrame”/>

</menuItem>
<!--This is a nested menu (pullright) containing two menu

items-->

<menu title=“Another Menu”>

<menuItem label=“Item 1”>

<request>ProcessMenuItem.do</request>
<request Attribute name=“type” value=“A5k”/>
<request Attribute name=“another”

value=“anotherVal”/>

<target value=“newFrame”/>
</menuItem>
<menuItem label=“Item 1”>
<request>ProcessMenuItem.do</request>

<requestAttribute name=“type” value=“A5k”/>
<requestAttribute name=“another”

value=“anotherVal”/>

<target value=“anotherFrame”/>

</menuItem>

</menu>
<!--Another menu item for this menu-->
<menuItem label=“item 2”>

<request>ProcessMenuItem.do</request>
<requestAttribute name=“type” value=“A5k”/>
<requestAttribute name=“another” value=“anotherVal”/>
<target value=“anotherFrame”/>

</menuItem>
<menuItem label=“item 3”>

<request>ProcessMenuItem.do</request>
<requestAttribute name=“type” value=“A5k”/>
<requestAttribute name=“another” value=“anotherVal”/>
<target value=“newFrame”/>

</menuItem>

</menu>

</managementApp>

FIG. 6B illustrates the tags that contain cliElement tag 86 in more detail. The registration descriptor contains a cliElement tag 86 when the plug-in application wishes to employ the CLI capabilities of the management application 22. The CLI capabilities include the ability to interact with clients that employ a CLI rather than a GUI-based web browser interface. In addition, the management console may provide CLI scripting services, as described in co-pending application A Method and System for Managing Registers, which is incorporated by reference herein. Plug-in applications 26 may wish to execute their own set of CLIs that are provided to CLI clients 18. SubCommand tag 130 is provided for each command that the plug-in application executes (i.e., each CLI command that is handled by the plug-in application). The subcommand tag 130 includes a number of additional tags. These additional tags include the name tag 132 that identifies the name of the CLI command and the request path tag 134 that associates the CLI command to the action class that handles browser requests that match the command. The sharedAction tag 136 indicates that the CLI command may be so similar to a browser task that a same action class can handle the CLI command. The presence of this tag 136 indicates such a case.

The id tag 128 is used by the CLI client and the management console 22 in conjunction with the sharedAction tag 136 to determine the proper request URI for the task. The id tag 138 contains a key attribute and a value attribute.

An optionElement tag 140 may be provided for each CLI option that is sent as a parameter value or a request attribute along with a CLI command. The optionElement tag 140 contains a number of tags including the name tag 142, which holds the name of the parameter or request attribute that matches the option. The type tag 144 may hold a string type or a boolean type value specifying the type of the parameter or attribute. The flag tag 146 is the character or characters that are passed to the CLI command to activate the option. The description tag 148 holds the string that describes the option. The optional tag 150 indicates whether the option is required or whether the option is optional. The multiple tag 152 indicates whether the option takes multiple arguments or a single argument. The default tag 154 specifies a default value, if any, for the optionElement. The secure tag 156 indicates whether the data contained in this option is of a sensitive nature and to be handled in a special way. Lastly, the hidden tag 158 indicates whether the option is to be hidden or not. It is an optional tag that is used to indicate that a user might not be interested in seeing this option listed in the help session because it is neither necessary nor relevant to the completion of a given task.

A DTD is defined for the cliElement portion. An example of such a DTD is as follows:

<?xml version=“1.0” encoding=“UTF-8”?>
<!ELEMENT cliElement (subcommand+)>
<!ELEMENT flag (#PCDATA)>
<!ELEMENT managementApp (browserElement, cliElement)>
<!ELEMENT name (#PCDATA)>
<!ELEMENT optionElement (name, type, flag, description, optional,
multiple, default, secure, hidden)>
<!ELEMENT requestPath EMPTY>
<!ELEMENT requestAttribute EMPTY>
<!ELEMENT request (#PCDATA)>
<!ELEMENT subCommand (name, requestPath, sharedAction?,id?,
optionElement+)>
<!ELEMENT type (#PCDATA)>
<!ELEMENT description (#PCDATA)>
<!ELEMENT optional (#PCDATA)>
<!ELEMENT multiple (#PCDATA)>
<!ELEMENT default (#PCDATA)>
<!ELEMENT secure (#PCDATA)>
<!ELEMENT hidden (#PCDATA)>
<!ELEMENT sharedAction (#PCDATA)>
<!ELEMENT id (#PCDATA)>
<!ATTLIST cliElement

version CDATA #REQUIRED

>
<!ATTLIST id

key CDATA “src”
value CDATA #REQUIRED

An example of a portion of a registration descriptor that conforms with the DTD for the cliElement is as follows:

<?xml version=“1.0” encoding=“UTF-8”?>
<managementApp>

<!--information necessary to run this application through the browser

goes here.-->

<browserElement/>
<!--CLI specific information, including information needed for

scripting, goes here.-->

<!--EXAMPLE CLI for the command fabric -user user1 -pass xyz

-saluser sal1 -->

<!-- -salpass pqr -webserver ns-east-65 -webport 8080 -salserver

ns-east-65 -zoned -->

<cliElement>

<subCommand>

<!--actual CLI command that a user would type at the

prompt-->

<name>fabrics</name>
<!--the variable mapped as ‘path’ in the struts-config.xml

file.-->

<request>fabrics.do</request>
<!--miscellaneous attributes that are not passed in as CLI

options-->

<requestAttribute/>
<!--There will be multiple of these per subCommand

element. This defines a CLI option.-->

<optionElement>

<name>username</name>
<flag>-user</flag>
<type>string</type>

</optionElement>
<optionElement>

<name>password</name>
<flag>-pass</flag>
<type>string</type>

</optionElement>
<optionElement>

<name>salusername</name>
<flag>-saluser</flag>
<type>string</type>

</optionElement>
<optionElement>

<name>salpass</name>
<flag>-salpass</flag>
<type>string</type>

</optionElement>
<optionElement>

<name>webserverhost</name>
<flag>-webserver</flag>
<type>string</type>

</optionElement>
<optionElement>

<name>webport</name>
<flag>-webport</flag>
<type>string</type>

</optionElement>
<optionElement>

<name>salserver</name>
<flag>-salserver</flag>
<type>string</type>

</optionElement>
<optionElement>

<name>zoned</name>
<flag>-zoned</flag>
<type>boolean</type>

</optionElement>

</subCommand>
<sessionElement>

<name/>
<request/>
<requestAttribute/>
<optionElement>

<flag/>
<type/>
<name/>

</optionElement>

</sessionElement>

</cliElement>

</managementApp>

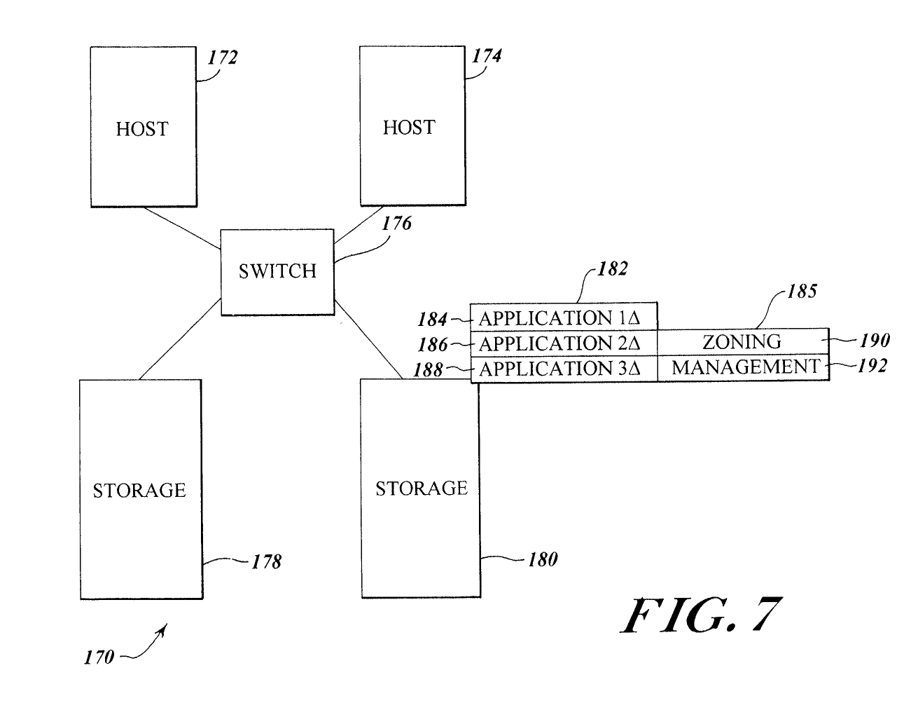

One example of a management console that may be used with the illustrative embodiment of the present invention is one that manages a storage area network (SAN). The management console may act as a console that provides a visual representation of components in the SAN. Management functionality relative to specific components in the SAN may be accessed via the management console. A plug-in application may extend the functionality of the management console. FIG. 7 shows an example of a user interface that may be provided by the management console 22 in such a case. A plug-in application embellishes the functionality provided by the management console to facilitate zoning. Zoning specifies what storage facilities are visible to a given host. In the example depicted in FIG. 7, the management console provides visual representations of hosts 172 and 174, a switch 176 and storage facilities 178 and 180 as part of a SAN 170. When a cursor is positioned over an icon 180 that represents storage facility the console takes steps to generate a context menu 182 which is displayed for management functionality that is available relative to the storage facility 180. A separate menu item 184, 186 and 188 may be provided for each of the three plug-in applications that have registered with the management facility (i.e., application 1, application 2, and application 3). Suppose that application 2 provides the menu items in the menu 189 such that when the application 2 menu item 186 is selected, a zoning option 190 and a management option 192 are displayed in the cascading menu 189. The user then may select to access the zoning functionality by selecting menu item 190 to modify existing zoning. The plug-in application (i.e., application 2) is responsible for declaring the menu 189 and the menu items 190 and 192 in its registration descriptor. The registration service will automatically generate the menus from this information.

For the above-described example it is helpful to see how the components of the management application and plug-in application interact. FIGS. 1A and 1B are referenced in considering this example. The client 16 initiates a request that is sent by the web browser 34 over the network 14 to the management console 22. The client 16 requests SAN information by positioning the mouse cursor over the source facility icon 180 (FIG. 7) and selecting menu items 186 and 190. A controller servlet 25 (FIG. 1B) forwards the request to an appropriate action class instance 31 that responds to the zoning request. The action class may retrieve any necessary information from sources, such as a topology service. JavaBean components 27 are created and pushed into the management application context as needed. The action class 31 then tells the controller servlet 25 how the request should be forwarded. The request may then be forwarded to a JSP to construct a user interface response as the return to the client 16. The JSP may request data from the JavaBean components to build the appropriate response and then forwards the response to the client.

While the present invention has been described with reference to an illustrative embodiment thereof, those skilled in the art will appreciate that various changes in form and detail may be made without departing from the intended scope of the present invention as defined in the appended claims.

1. In an electronic device interfaced with a network, a method, comprising the steps of:
executing a program on the electronic device; and
dynamically registering a plug-in application with the program without ceasing the executing of the program, said plug-in application operating in conjunction with the program to provide enhanced functionality for the program.

2. The method of claim 1, wherein the step of dynamically registering comprises:
providing a registration descriptor holding information regarding the plug-in application; and
processing the registration descriptor to complete the registering of the plug-in application.

3. The method of claim 2, wherein the registration descriptor is a file.

4. The method of claim 2, wherein the step of dynamically registering further comprises:
storing the registration descriptor at a designated location to indicate that the registration descriptor is to be processed.

5. The method of claim 4, wherein the electronic device has access to a directory structure containing sub-directories and wherein the designated location is in a selected one of the sub-directories.

6. The method of claim 1, wherein the electronic device is a computer system.

7. The method of claim 1, wherein the electronic device is a web server.

8. The method of claim 1, wherein the program has a client that interacts with the program via a web browser.

9. The method of claim 1 further comprising the step of statically registering additional plug-in applications the program upon initialization of the program.

10. The method of claim 1, wherein the plug-in application provides dynamic web content.

11. In a server, a method, of comprising the steps of:
providing information regarding an application at a specified storage location; and
in response to the information being at the specified storage location, registering the application for use in conjunction with a program on the server to provide additional functionality for the program.

12. The method of claim 11, wherein the step of registering the application includes processing the information regarding the application to perform the registering.

13. The method of claim 11, wherein the information regarding the application is encapsulated in a file.

14. The method of claim 13, wherein the file is an extensible mark-up language (XML) file.

15. The method of claim 11, wherein a client accesses the server via a web browser to interact with the program.

16. The method of claim 11, wherein other applications are registered with the program.

17. The method of claim 11, wherein the program is initialized to prepare the program for execution and wherein the registering is performed dynamically during execution of the program after the program has been initialized.

18. The method of claim 11, wherein the program is initialized to prepare the program for execution and wherein the registering is performed during initialization of the program.

19. In a distributed environment having a server and clients that access the server, a method, comprising the steps of:
providing a management software package on the server for managing items in the distributed environment;
providing a location wherein add-on programs may deposit information regarding the add-on programs to register with the management software package, said add-on programs enhancing functionality of the management software package; and
processing the information at the location to register add-on programs that have deposited information at the location with the management software package so that the add-on programs that are registered may be executed in conjunction with the management software package.

20. A medium for use in an electronic device that is interfaced with a network, wherein a program is executing on the electronic device, said medium holding instructions for dynamically registering a plug-in application with the program without ceasing the executing of the program, said plug-in application operating in conjunction with the program to provide enhanced functionality for the program.

21. The medium of claim 20, wherein the dynamic registering comprises
providing a registration descriptor holding information regarding the plug-in application; and
processing the registration descriptor to complete the registering of the plug-in application.

22. The medium of claim 21, wherein the registration description is a file.

23. The medium of claim 20, wherein the program has a client that interacts with the program via a web browser.

24. The medium of claim 20, wherein the method further comprises statically registering additional plug-in applications the program upon initialization of the program.

25. The medium of claim 20, wherein the plug-in application provides dynamic web content.

26. A medium for use in a server where information regarding an application is provided at a specified storage location that is accessible by the server, said medium holding instructions for registering the application for use in conjunction with the program on the server to provide additional functionality for the program in response to information being at the specified storage location.

27. The medium of claim 26, wherein the program is initialized to prepare the program for execution and wherein the registering is performed dynamically during execution of the program after the program has been initialized.

28. The medium of claim 26, wherein the program is initialized to prepare the program for execution and wherein the registering is performed during initialization of the program.
